(19) United States
(12) Patent Application Publication
(10) Pub. No.: US 2026/0311930 A1
(43) Pub. Date: Oct. 8, 2026

(54) Plug-in connection part for inductively transmitting energy and/or signals in a potentially explosive environment, connecting device and measuring system

(71) Applicant: Knick Elektronische Messgeräte GmbH & Co. KG, Berlin (DE)

(72) Inventors: Andreas LEHMANN, Berlin (DE); Peter ACKERS, Berlin (DE)

(73) Assignee: Knick Elektronische Messgeräte GmbH & Co. KG, Berlin (DE)

(21) Appl. No.: 19/484,861

(22) PCT Filed: May 13, 2024
(86) PCT No.: PCT/EP2024/063014

§ 371 Date: Nov. 15, 2025

(30) Foreign Application Priority Data
May 16, 2023 (DE) 10 2023 204 576.1

(51) Int. Cl. H01F 38/14; H02J 50/10

(52) U.S. Cl. CPC H01F 38/14; H02J 50/10; H01F 2038/143

(57) ABSTRACT

A plug-in connection part (4) for inductively transmitting energy and/or signals in a potentially explosive environment, in particular for a measuring system (1) includes an electrical circuit (28) with a circuit connection (29) for supplying the plug-in connection part (4) with electrical energy, and a primary coil (23) in the circuit (28) for inductive coupling with a secondary coil (11), and an ignition suppression means (39) in the circuit (28) for preventing ignition in the event of a fault by limiting the back action of the electrical energy to the circuit connection (29). A connecting device (2) for inductively transmitting energy and/or signals includes such a plug-in connection part (4) and a measuring system includes such a connecting device (2).

### CROSS-REFERENCE TO RELATED APPLICATION

This application is a national stage application, filed under 35 U.S.C. § 371, of International Patent Application PCT/EP2024/063014, filed on May 13, 2024, which claims the benefit of German Patent Application DE 10 2023 204 576.1, filed on May 16, 2023. The content of German patent application DE 10 2023 204 576.1 is incorporated herein by reference.

### TECHNICAL FIELD

The invention relates to a plug-in connection part for inductively transmitting energy and/or signals in a potentially explosive environment, in particular for a measuring system. The invention further relates to a connecting device for inductively transmitting energy and/or signals. The invention also relates to a measuring system.

### BACKGROUND

DE 10 2018 122 015 A1 discloses an inductive interface for inductively transmitting signals between a primary side and a secondary side, wherein the inductive interface establishes a detachable signal connection between a parent unit and a field device. In order to ensure the suitability of the field device for use in a potentially explosive environment and at the same time keep its dimensions as small as possible, a circuit assembly is arranged on a circuit carrier carrying the secondary coil to prevent sparking. There is a continued need for an inductive plug-in connection which is particularly robust in terms of signal transmission and can be operated particularly safely in a potentially explosive environment.

DE 197 19 730 C1 discloses a plug-in connection for inductively transmitting energy and signals in a potentially explosive environment with limiting devices intended to prevent ignition in the event of a fault. The limiting devices are designed to provide ignition protection in the region of the plug-in connection and in the region of secondary-side sensors and actuators. The disadvantage is that the ignition hazard resulting from back action of the electrical energy taken in via a voltage-source-side circuit connection to the circuit connection is not reduced.

### SUMMARY

One object of the invention is to provide an improved plug-in connection part for inductively transmitting energy and/or signals in a potentially explosive environment, which can in particular be operated particularly safely in such an environment and which ensures energy and/or signal transmission in a particularly reliable and robust manner.

This object is achieved by a plug-in connection part as disclosed and claimed. It has been recognised that a plug-in connection part for inductively transmitting energy and/or signals in a potentially explosive environment, in particular for a measuring system, with a circuit connection for supplying the plug-in connection part with electrical energy and a primary coil can have an ignition suppression means, which is designed to prevent ignition, in particular in the event of a fault, by limiting the back action of the electrical energy to the circuit connection. As a result, the plug-in connection part is particularly safe to operate, in particular in a potentially explosive environment. Due to the fact that the ignition suppression means is arranged on the primary-side plug-in connection part, in particular with regard to the inductive transmission point on the plug-in connection part arranged at a power source, the inductive energy and/or signal transmission can be designed to be particularly robust without impairing its suitability for use in potentially explosive environments. Thanks to the design of the plug-in connection part with the ignition suppression means, the ignition suppression effect can actually be improved even if the plug-in connection part has a means for promoting particularly robust energy and/or signal transmission. This ensures that inductive energy and signal transmission is particularly robust against external interference, such as electromagnetic fields, and/or mechanical influences, in particular contamination. Thanks to the ignition suppression means, the plug-in connection part, in particular a device formed therewith and/or a measuring system, can be designed to be safe in such a way that a complex spark test required for experimentally demonstrating explosion safety can be avoided. Such a plug-in connection part can thus be provided particularly economically for use in a potentially explosive environment.

Signals can generally have a non-negligible energy component. The ignition suppression means used for explosion protection preferably also works for this energy component, in particular for any electrical energy present in the plug-in connection part. In other words, the ignition suppression means can be designed to prevent ignition in the event of a fault by limiting the back action of electrical energy, in particular energy and/or signals, to the circuit connection. Signals can be used to transmit analogue and digital information, i.e. enable data transmission, for example.

Instead of diodes, other integrated or non-integrated components with a diode-like function can also be used. For example, under certain conditions, so-called shunt voltage regulators or other components with a non-linear characteristic curve and suitable threshold or breakdown voltages are also suitable.

The circuit connection, the primary coil and/or the ignition suppression means are preferably integrated into the electrical circuit, in particular at least in sections, in particular predominantly, arranged on the same circuit board, in particular a single-layer or multi-layer circuit board, and/or arranged in the same housing of the plug-in connection part at least in sections, in particular completely. The circuit connection and/or primary coil and/or ignition suppression means are preferably materially connected to one another, in particular by means of a soldered connection.

The plug-in connection part is preferably designed to be intrinsically safe in terms of explosion protection, in particular electrical ignition protection. The plug-in connection part preferably provides intrinsic safety for operation in a gas explosion hazardous area and/or in a dust explosion hazardous area, in particular at least Category 2, in particular at least Category 1, in particular Category 0. For this, the energy that can be stored in the plug-in connection part is preferably limited to a safe level.

The fault can comprise at least one electrical line, in particular for conducting energy and/or signals, in particular electrical power, in particular a signal line, supply potential line and/or reference potential line, being interrupted, in particular unintentionally and/or contrary to operating instructions and/or an electrical connection, for example a short-circuit, being unintentionally established, in particular in this order or vice versa, for example due to damage, in particular mechanical damage. For example, any short-circuit and/or opening of the electrical line, in particular a faulty soldering point, a cable break, in particular electrically conductive liquid penetrating the circuit, and/or improper disconnection of the plug-in connection can result in such a fault.

The transmission of energy and/or signals can be understood as meaning the transmission of electrical energy, in particular power, and/or the transmission of information, in particular an electrical signal. The transmitted electrical power can, for example, be used to supply an electrical consumer, in particular a data processing means and/or a sensor. The energy and/or signals are preferably transmitted between the primary coil and a secondary coil, in particular in both directions and/or from the primary coil to the secondary coil and/or from the secondary coil to the primary coil. Electrical power is preferably transmitted from the primary coil to the secondary coil, in particular to operate a secondary-side circuit, in particular the mating plug-in connection part and/or at least one sensor. Data exchange can take place in both directions, preferably at least from the secondary coil to the primary coil.

The plug-in connection part is preferably the connection part arranged on the primary side of the inductive transmission point, in particular on the side of a power source. The plug-in connection part is in particular designed for releasable, in particular for non-destructive releasable, connection with a mating plug-in connection part. A locking mechanism, in particular forming a bayonet lock, is preferably provided for reversibly securing the plug-in connection.

The circuit connection is designed to exchange electrical power and/or electrical signals with the plug-in connection part. A signal processing device, in particular formed separately from the plug-in connection part, arranged in particular spaced apart therefrom, is preferably in signal connection with the circuit connection. The signal processing device is also referred to as a transmitter. The signal processing device preferably serves as a power source for the plug-in connection part. The circuit connection can comprise electrical contacts, in particular solder contacts and/or clamping contacts. The circuit connection is preferably designed to connect the circuit with a connection cable, in particular to the signal processing device. The circuit connection can have power supply contacts, in particular at least one operating voltage contact and/or a reference potential contact, and/or at least one, in particular at least two, signal line contacts, in particular data contacts, in particular data bus contacts. The at least one operating voltage contact is also referred to as supply potential contact and the at least one operating voltage is also referred to as supply potential.

Ignition can result from an ignition spark, in particular if it is not shielded from the potentially explosive environment. An ignition effect can potentially also occur when the surface of an object exceeds a certain temperature. The ignition suppression means preferably counteracts at least one, in particular both, ignition mechanisms.

The ignition suppression means preferably has an electrical and/or electronic component, in particular for limiting the maximum electrical energy and/or power that can be transmitted from the circuit to the circuit connection and/or the maximum voltage that can be applied between any two contacts of the circuit connection. The ignition suppression means is electrically contacted in the circuit preferably between the primary coil and the circuit connection, in particular directly connected to the circuit connection.

The direct electrical connection of a first object to a second object is understood in particular as meaning that only line resistances, in particular line resistances of no more than 1 ohm, in particular no more than 100 ohms, in particular no more than 1 kohm, but no other components, in particular no resistors and/or no capacitors and/or no inductors and/or no control elements are arranged along the electrical connection between the first object and the second object.

Limiting the back action of the electrical energy to the circuit connection is in particular understood as meaning that the maximum possible return flow of energy, in particular per unit of time, i.e. the maximum electrical power, to the circuit connection and/or the maximum electrical voltage that can be transmitted from the plug-in connection part, in particular the circuit, to the circuit connection is limited. The energy is in particular that energy taken in by means of the plug-in connection part via the circuit connection and/or stored by the plug-in connection part at least for a short period.

According to one aspect of the invention, the plug-in connection part is provided with encapsulation, in particular potting. The electrical circuit is preferably encapsulated, at least in sections, in particular completely, in particular sealed against liquids and/or gases, in particular enclosed and/or potted. The potting can comprise an electrically insulating material, in particular a plastic material, in particular consist thereof. The potting can be designed to be thermally conductive for heat dissipation from the circuit. The plug-in connection part, in particular the electrical circuit, and/or a connection cable, can have an electric and/or magnetic shield.

The plug-in connection part is preferably part of a measuring system with a sensor for detecting a measurement variable. The plug-in connection part can be arranged opposite the sensor on the side of an energy supply and/or with regard to the inductive transmission point.

According to one aspect of the invention, the circuit can have an amplifier device, in particular for amplifying an electrical signal supplied to the primary coil and/or received by the primary coil. The amplifier device preferably has at least one inductive component and/or a capacitive component and/or a component for the at least short-term storage of electrically supplied, in particular electrical and/or magnetic energy. The inductive component can have an electrical inductance of at least 0.1 mH, in particular at least 0.5 mH, in particular at least 1 mH, in particular at least 10 mH, and/or no more than 100 mH, in particular no more than 10 mH. The capacitive component can have an electrical capacitance of at least 1 μF, in particular at least 10 μF, in particular at least 100 μF, and/or no more than 1 mF, in particular no more than 100 μF. The amplifier device, in particular the at least one inductive and/or capacitive component, can have an energy storage capacity of at least 1 μJ, in particular at least 10 μJ, in particular at least 50 J, in particular at least 100 μJ, in particular at least 200 μJ, in particular at least 400 μJ, and/or no more than 100 mJ, in particular no more than 50 mJ, in particular no more than 10 mJ, in particular no more than 1 mJ, in particular no more than 500 μJ, i particular no more than 500 μJ, in particular when used as intended, in particular when operated at a specified operating voltage. In particular, the plug-in connection part, in particular the electrical circuit, in particular the amplifier device, can have an overall inductance and/or an overall capacitance and/or an overall energy storage capacity in accordance with at least one of the aforementioned ranges.

The amplifier device can have an electrical resonant circuit, in particular a series resonant circuit and/or a parallel resonant circuit, in particular comprising the at least one inductive element and the at least capacitive element. The primary coil is preferably part of the electrical resonant circuit. The amplifier device preferably comprises a Class E amplifier, in particular consists thereof. The amplifier device advantageously ensures that signals, in particular data signals, can be transmitted particularly reliably and robustly via the inductive connection. However, the amplifier device increases the energy storage capacity of the circuit. The ignition suppression means can be designed to limit possible back action of the electrical energy stored in the amplifier device to the circuit connection.

The amplifier device can have a supply inductor, which is connected upstream of the electrical resonant circuit. For the energy-efficient operation of the resonant circuit, the electrical inductance of the supply inductor must be sufficiently high. This increases the energy storage capacity of the circuit, in particular of the amplifier device. The ignition suppression means limits the amount of possible back action of the electrical energy stored in the supply inductor to the circuit connection.

According to one aspect of the invention, the amplifier device has an overall electrical inductance of at least 0.1 mH, in particular at least 0.5 mH, in particular at least 1 mH, in particular at least 5 mH. The overall electrical inductance of the amplifier device preferably comprises at least the electrical inductance of the supply inductor and/or the electrical inductance of the primary coil.

According to another aspect of the invention, the ignition suppression means is arranged, in particular electrically contacted, between the amplifier device and the circuit connection. The ignition suppression means can be electrically connected in parallel to the amplifier device, in particular between a supply potential contact and a reference potential contact of the circuit connection, in particular with electrical contact between the amplifier device and the circuit connection, or in series with the amplifier device, in particular between the supply potential contact or the reference potential contact and the amplifier device.

The ignition suppression means can electrically contact the operating voltage contact and/or a reference potential contact of the circuit connection, in particular directly.

According to another aspect of the invention, the plug-in connection part has a power conditioning device in the circuit, in particular along the electrical line between the circuit connection and the ignition suppression means. The power conditioning means can comprise a voltage smoothing element and/or a voltage regulator and/or a voltage divider. The power conditioning means can be designed to provide at least one, in particular at least two, voltage levels for operating the plug-in connection part. The ignition suppression means is preferably electrically contacted along the electrical line between the power conditioning device and the primary coil, in particular the amplifier device, in particular in series, in particular arranged between the supply potential contact or the reference potential contact and the power conditioning device and/or with the amplifier device, and/or in parallel, in particular between a supply potential contact and a reference potential contact, to the power conditioning device and/or amplifier device, in particular primary coil.

The plug-in connection part can have other assemblies, in particular a communication device, in particular a digital assembly and/or a modem assembly and/or a modulator/demodulator assembly and/or a frequency filter, in particular a bandpass filter.

According to another aspect of the invention, the ignition suppression means is directly connected to the circuit connection. As a result, the ignition suppression means limits the back action of electrical energy to the circuit connection particularly reliably.

According to another aspect of the invention, the plug-in connection part can have a connection cable at the circuit connection. The ignition suppression means can be designed to limit the back action of electrical energy on the connection cable, in particular to prevent an ignition effect in the connection cable, in particular in the event of a fault, in particular in the event of a contact failure and/or a line fault, for example a short-circuit or a cable break. The connection cable can have a shield. The connection cable preferably comprises at least two, in particular at least three, in particular at least four, cable cores. The connection cable, in particular the cable cores, are connected to the circuit connection, in particular corresponding connection contacts, preferably using a force-fit and/or material-bonded connection. The shield can also be connected to the housing and/or an additional and/or available contact of the circuit connection using a force-fit and/or material-bonded connection. The connection cable is preferably arranged at least in sections, in particular mostly, outside a housing of the plug-in connection part.

According to one aspect of the invention, the ignition suppression means can be designed to limit electrical energy and/or power potentially contributing to the ignition of a potentially explosive composition in the potentially explosive environment. The ignition suppression means can comprise at least one electrical resistor for the controlled energy dissipation, in particular of energy stored in the circuit, in particular in the amplifier device, in particular in the supply inductor. The ignition suppression means can have a voltage limiter and/or a power limiter, in particular a power regulator. The ignition suppression means can have a short-circuit element, such as a crowbar and/or a voltage limiter, in particular a shunt voltage limiter, which is arranged in particular in parallel to an energy-storing assembly of the plug-in connection part, for example in parallel to the amplifier device, in particular to the supply inductor and/or to the primary coil.

According to one aspect of the invention, the ignition suppression means has at least one diode, which is connected directly to the circuit connection, in particular to the reference potential contact and/or the operating voltage contact in particular for limiting a maximum connection voltage. The at least one diode can be a rectifier diode, in particular a silicon diode, and/or a Schottky diode and/or a Zener diode. A forward voltage of the diode is preferably in a range of 0.1 V to 10 V, in particular 0.2 V to 5 V, in particular 0.3 V to 2 V. A breakdown voltage, in particular of the Zener diode, is preferably in a range of 1 V to 30 V, in particular 1.5 V to 10 V, in particular 2 V to 7 V, in particular 3 V to 6 V. The ignition suppression means preferably has a bidirectional short-circuit element, in particular for limiting the amount of energy and/or voltage that can potentially be supplied to the circuit connection by the resonant circuit.

The at least one diode preferably limits the maximum electrical voltage that can be applied between at least two, in particular all, connection contacts of the circuit connection.

According to one aspect of the invention, the ignition suppression means has at least two of the diodes, in particular between two power supply contacts of the circuit connection. The at least two diodes are preferably directly connected to the power supply contacts, in particular to the operating voltage contact and/or to the reference potential contact, in particular parallel to one another and/or to the amplifier device and/or to the power conditioning device. The at least two diodes are preferably rectifier diodes, in particular Schottky diodes. The forward direction of the at least two diodes is preferably oriented from the reference potential contact to the operating voltage contact.

The ignition suppression means can be designed with single or multiple redundancy, in particular with at least double, in particular at least triple, redundancy. For this purpose, the at least two, in particular at least three, diodes can be connected parallel to one another.

According to one aspect of the invention, the ignition suppression means can have at least one, in particular at least two, in particular exactly two, diodes, in particular rectifier diodes, in particular Schottky diodes, between the operating voltage contact and the first signal line contact and/or between the first signal line contact and the reference potential contact and/or between the operating voltage contact and the second signal line contact and/or between the second signal line contact and the reference potential contact. The respective diode is preferably directly connected to the respective contact. The embodiment of the ignition suppression means with the at least two rectifier diodes preferably results in redundancy, in particular at least double, redundancy, for example in a parallel arrangement of the diodes, and thus in particularly reliable ignition suppression. An embodiment of the ignition suppression means with respectively one single diode, without redundancy, or a higher number, in particular at least double, in particular at least triple, redundancy is also possible.

According to one aspect of the invention, the ignition suppression means has at least two Zener diodes between two power supply contacts of the circuit connection, in particular between the operating voltage contact and the reference potential contact. The at least two Zener diodes are preferably directly electrically connected to the power supply contacts. For at least triple redundancy, the number of Zener diodes can be increased accordingly. An embodiment with one single Zener diode is alternatively possible to avoid redundancy.

According to one aspect of the invention, the ignition suppression means can have at least one diode and/or at least one resistor. The power conditioning device can be electrically connected between these and the operating voltage contact, in particular in a signal line direction. The ignition suppression means is preferably connected in series with the power conditioning device. The ignition suppression means can be connected in parallel to the amplifier device, in particular with the primary coil. A connection of the ignition suppression means preferably contacts an electrical line between the power conditioning device and the primary coil, in particular the amplifier device.

According to one aspect of the invention, the plug-in connection part, in particular the electrical circuit, can have an energy storage capacity, which exceeds an ignition limit when the plug-in connection part is used as intended. In particular, an ignition limit would be exceeded without the ignition suppression means. When used as intended, the plug-in connection part is operated with an in particular maximum permissible operating voltage. The operating voltage of the plug-in connection part is preferably in a range of 1 V to 30 V, in particular 1.5 V to 25 V, in particular 2 V to 12 V, in particular 2.25 V to 8 V, in particular 2.5 V to 4 V, preferably 3 V. The energy storage capacity of the plug-in connection part, in particular the circuit when used as intended, in particular the inductive and/or capacitive energy storage capacity, is preferably in a range of 1 μJ to 500 mJ, in particular 5 μJ to 100 mJ, in particular 10 μJ to 1 mJ, in particular 20 μJ to 500 μJ, in particular 40 μJ to 200 μJ.

Another object of the invention involves creating an improved connecting device for inductively transmitting energy and/or signals, which can in particular be operated safely in a potentially explosive environment and which ensures energy and/or signal transmission in a particularly reliable and robust manner.

This object is achieved by a connecting device for inductively transmitting energy and/or signals, in particular electrical power and/or signals, with a plug-in connection part in accordance with the above description and a mating plug-in connection part for reversibly releasable connection to the plug-in connection part. The advantages of the connecting device correspond to the advantages of the plug-in connection part. The connecting device is preferably further developed with at least one of the features described above in connection with the plug-in connection part.

The mating plug-in connection part preferably has a secondary circuit in which the secondary coil is arranged. The mating plug-in connection part can have an ignition suppression means in the secondary circuit for preventing an ignition effect in the event of a fault, in particular for limiting the back action of the electrical energy received by the mating plug-in connection part to the plug-in connection part, in particular to the primary coil.

The connecting device preferably has a locking mechanism for reversibly releasable locking of the plug-in connection between the plug-in connection part and the mating plug-in connection part. The locking mechanism can be designed as a latching connection and/or as a bayonet connection. The locking mechanism preferably comprises a locking sleeve that can be rotated in particular about a central longitudinal axis of the connecting device.

The connecting device is preferably designed to be intrinsically safe with regard to electrical explosion protection, in particular is suitable for safe operation in a potentially explosive environment.

Another object of the invention involves creating an improved measuring system, which can in particular be operated particularly safely in a potentially explosive environment and which ensures the transmission of sensor signals in a particularly reliable and robust manner.

This object is achieved by a measuring system with at least one sensor and a connecting device in accordance with the above description. The at least one sensor can comprise a pH sensor and/or a temperature sensor and/or a pressure sensor and/or a humidity sensor and/or a redox sensor and/or an oxygen sensor and/or a conductivity sensor and/or a liquid sensor and/or a gas sensor.

The at least one sensor is preferably connected to the mating plug-in connection part in a signal-transmitting and/or mechanical, in particular rigid, manner. The at least one sensor can be fitted to a housing, in particular the secondary housing, of the mating plug-in connection part. The at least one sensor is preferably fitted to the mating plug-in connection part by means of a cable or directly, in particular wirelessly.

The measuring system can have at least two, in particular at least three, in particular at least four of the sensors, in particular arranged on the same mating plug-in connection part.

The sensor signals detected by the at least one sensor are preferably transmitted inductively, in particular via the inductive coupling path of the primary coil and secondary coil, between the mating plug-in connection part and the plug-in connection part. Energy and/or signals are preferably transmitted via this inductive coupling path. In particular, the at least one sensor is supplied with energy via this inductive coupling path.

According to one aspect of the invention, the measuring system can have a signal processing device for processing the sensor signals transmitted by the connecting device. The signal processing device can provide electrical energy to supply the plug-in connection part and/or the mating plug-in connection part and/or the at least one sensor, in particular acting as an energy source for these. The signal processing device preferably provides an operating voltage between the operating voltage contact and the reference potential contact.

The signal processing device is preferably connected to the plug-in connection part by means of the connection cable.

The signal processing device can have a user interface, in particular for inputting and/or outputting information, in particular an output unit, in particular a display and/or a loudspeaker and/or an input unit, in particular at least one touch-sensitive and/or pressure-sensitive element.

The signal processing device can have a data transmission unit for wired or wireless transmission of data, in particular a LAN interface and/or a radio interface and/or a WiFi interface. The signal processing device is preferably in signal connection with a central processing unit, in particular a control room. The signal processing device can have at least one electronic processing unit, in particular a processor, in particular a microcontroller, for processing the sensor signals.

According to one aspect of the invention, the signal processing device is designed to be intrinsically safe with regard to explosion protection. The signal processing device can have an ignition suppression means for preventing an ignition effect in the event of a fault, in particular by limiting the maximum electrical energy, in particular per unit of time, and/or voltage that can be applied to the connecting device, in particular to the plug-in connection part and/or to the connection cable.

Due to the fact that the plug-in connection part has the ignition suppression means, it is possible to reliably prevent ignition in the event of a fault, regardless of whether the connection of the connection cable is intact. This is applicable in particular in the event that an amount of energy that is sufficient for ignition can be stored, in particular is stored, in the plug-in connection part. Particularly safe operation of the measuring system in the potentially explosive environment can in particular be achieved by virtue of the fact that furthermore the measuring system and the mating plug-in connection part are designed to be intrinsically safe, in particular with an ignition suppression means.

Further features, details and advantages of the invention result from the following description of a plurality of exemplary embodiments based on the figures. In the drawing:

### BRIEF DESCRIPTION OF THE DRAWINGS

FIG. 1 shows a perspective, partially sectional view of a measuring system with a connecting device for inductively transmitting energy and/or signals, having a plug-in connection part with an ignition suppression means for preventing ignition in the event of a fault and a mating plug-in connection part,

FIG. 2 shows a schematic view of the connecting device shown in FIG. 1 with the plug-in connection part and the mating plug-in connection part,

FIG. 3 shows a schematic circuit diagram of the mating plug-in connection part shown in FIG. 1 with a sensor circuit connection for forming a signal connection with a sensor and a secondary coil for inductive coupling with the plug-in connection part, in particular a primary coil of the plug-in connection part,

FIG. 4 shows a schematic circuit diagram of the plug-in connection part shown in FIG. 1 according to a first embodiment, wherein the ignition suppression means has ten diodes, in particular two Zener diodes and eight Schottky diodes, and

FIG. 5 shows a schematic circuit diagram of a plug-in connection part according to another embodiment, wherein the ignition suppression means has two diodes, in particular two Schottky diodes, and a resistor, which are contacted in an electrical circuit between an amplifier device and a power conditioning device of the plug-in connection part.

### DETAILED DESCRIPTION

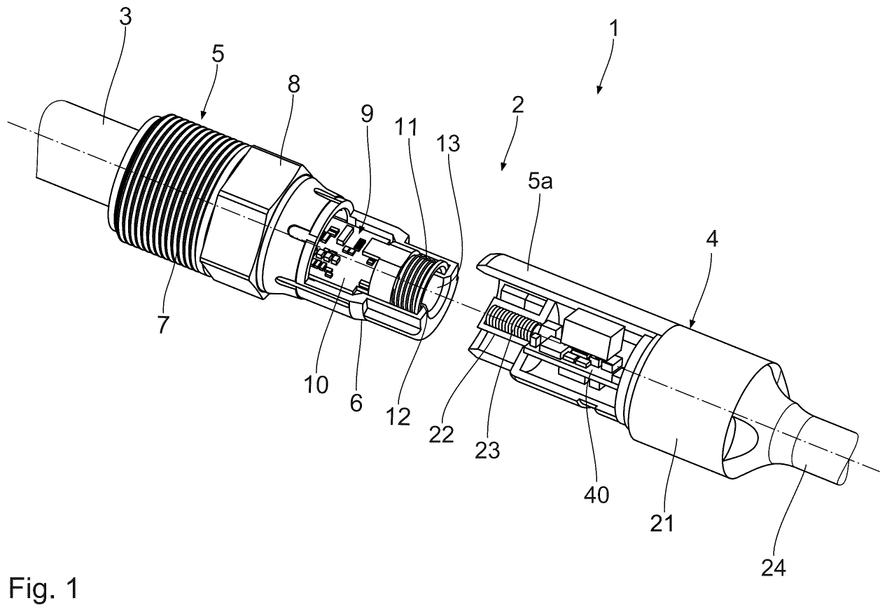

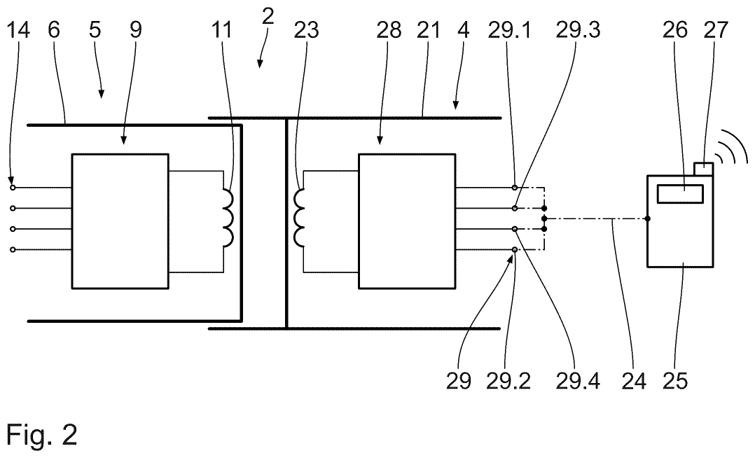

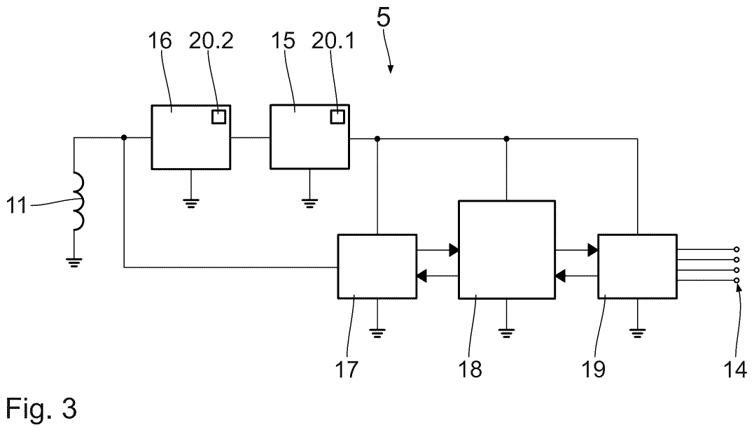

A first exemplary embodiment of a measuring system 1 with a connecting device 2 and a sensor 3 connected thereto is described with reference to FIG. 1 to 4.

The sensor 3 is designed as a pH sensor. The sensor 3 can alternatively or in addition be designed as a redox sensor, a conductivity sensor, an oxygen sensor, a temperature sensor, a pressure sensor and/or as a sensor for other process-relevant parameters. The sensor can have an optical, inductive and/or electrode-based measuring device.

The connecting device 2 has a plug-in connection part 4 and a mating plug-in connection part 5 that can be reversibly connected thereto. The sensor 3 is preferably rigidly connected to the mating plug-in connection part 4, in particular a housing 6 of the mating plug-in connection part 5.

The housing 6 of the mating plug-in connection part 5 has a thread 7, in particular an external thread. The thread 7 is designed to fasten the mating plug-in connection part 5 to a measuring point. The thread 7 is in particular designed in such a way that the mating plug-in connection part 5 can be attached to a measuring chamber wall such that the sensor 3 is arranged in the measuring chamber and the mating plug-in connection part 5 is arranged at least in sections outside the measuring chamber. The measuring chamber wall is sealed by the mating plug-in connection part 5, in particular a sealing element, preferably in a fluid-tight manner, in particular in a gas-tight manner. The housing 6 of the mating plug-in connection part 5 has a tool interface 8 for driving the mating plug-in connection part 5 in rotation, in particular for screwing the thread 7 to the measuring chamber wall.

The mating plug-in connection part 5 is further described in detail with reference to FIG. 1 to 3. The mating plug-in connection part 5 comprises an electrical secondary circuit 9, which is preferably formed on a secondary circuit board 10 at least in sections, in particular predominantly. A secondary coil 11 is arranged in the secondary circuit 9. The secondary coil 11 is part of an inductive coupling path for the transformer-based transmission of energy and/or signals.

The secondary coil 11 is wound onto a secondary coil former 12, which is in particular in the form of a hollow cylinder. A central recess 13 of the secondary coil former 12 is cylindrical.

The secondary circuit 9 has a sensor circuit connection 14 for establishing an energy-transmitting and/or signal-transmitting connection with the sensor 3. The sensor circuit connection 14 is designed to supply the sensor 3 with energy and transmit sensor signals. For this purpose, the sensor circuit connection 14 comprises a plurality of, in particular at least 3, in particular at least 4, connection contacts, which are preferably connected to a corresponding mating connection contact of the sensor 3, in particular using a material-bonded connection, in particular by soldering.

The secondary circuit 9 preferably further has at least one of the following devices: a secondary power conditioning device 15 for providing at least one supply voltage, in particular at least two supply voltages, and/or a secondary rectifier device 16 for rectifying an alternating voltage induced in the secondary coil 11 and/or a secondary communication device 17, in particular a modulator/demodulator assembly and/or a modem assembly, for exchanging energy and/or signals via the secondary coil 11 and/or a sensor communication device 18 for exchanging data with the sensor 3 and/or a sensor signal processing device 19, in particular with an analogue-to-digital converter, for processing the sensor signals. The sensor communication device 18 can be part of a digital assembly for processing digital data.

The mating plug-in connection part 5, in particular the secondary power conditioning device 15 and/or the secondary rectifier device 16, can have a secondary ignition suppression means 20.1, 20.2 for preventing ignition in the event of a fault by limiting the maximum electrical power that can be transmitted to the secondary coil 11 and/or the sensor circuit connection 14.

In order to mechanically connect the plug-in connection part 4 to the mating plug-in connection part 5, these interact in the form of a plug-in connection. A reversibly releasable locking mechanism 5a, in particular a bayonet lock, prevents the plug-in connection from becoming disconnected, in particular unintentionally.

The measuring system 1 and the plug-in connection part 4 are further described in detail with reference to FIGS. 1, 2 and 4. The plug-in connection part 4 has a housing 21. A cylindrical protrusion 22 is arranged on the housing 21 and is designed to engage into the cylindrical recess 13 of the mating plug-in connection part 5, in particular of the housing 6 of the mating plug-in connection part 5. A primary coil 23 of the plug-in connection part 4 is arranged in the cylindrical protrusion 22 and is inductively coupled to the secondary coil 11 when the plug-in connection part 4 engages with the mating plug-in connection part 5, in particular when the cylindrical protrusion 22 engages with the recess 13.

A connection cable 24 is provided on the mating plug-in connection part 4.

The connection cable 24 preferably establishes a signal connection to a signal processing device 25 of the measuring system 1. The connection cable 24 is preferably fixedly connected to the housing 21 of the plug-in connection part 4, in particular cannot be released with damage. In particular, the connection cable 24 can be connected to the housing 21 in a fluid-tight, in particular gas-tight manner.

The signal processing device 25 is preferably designed to supply the connecting device 2, in particular the plug-in connection part 4 and/or the mating plug-in connection part 5 and/or the sensor 3, with electrical energy and/or signals, in particular via the connection cable 24. The signal processing device 25 is designed to exchange data, in particular to receive sensor signals and/or send control signals, with the plug-in connection part 4. The signal processing device 25 can have a user interface 26 for inputting and outputting information, in particular with a display means for displaying information, in particular of the sensor signals, and/or a communication module 27, in particular a radio module, for the wired and/or wireless exchange of data, in particular with a control room and/or a central computing system.

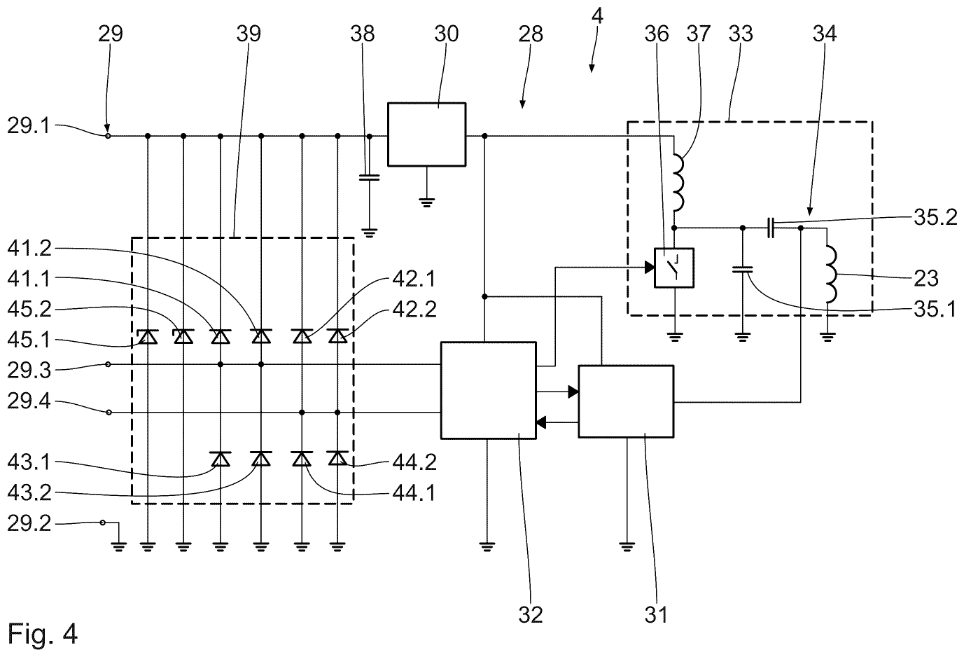

The plug-in connection part 4 according to a first exemplary embodiment is described with reference to FIG. 4. The plug-in connection part 4 is designed for inductively transmitting energy and/or signals, in particular electrical power and/or signals, in a potentially explosive environment. The plug-in connection part 4 has an electrical circuit 28 with a circuit connection 29. The primary coil 23 is arranged in the circuit 28. The connection cable 24 contacts the circuit connection 29.

The circuit connection 29 comprises an operating voltage contact 29.1, a reference potential contact 29.2, a first signal line contact 29.3 and a second signal line contact 29.4. The reference potential contact 29.2 is also referred to as a ground contact, or GND for short. An operating voltage provided to supply power to the measuring system 1, in particular the connecting device 2, in particular the plug-in connection part 4, is applied between the operating voltage contact 29.1 and the reference potential contact 29.2. The operating voltage contact 29.1 and the reference potential contact 29.2 are also referred to as power supply contacts 29.1, 29.2.

The plug-in connection part 4 comprises a power conditioning device 30 in the circuit 28. The power conditioning device 30 is connected, in particular directly, to the operating voltage contact 29.1 and the reference potential contact 29.2. The power conditioning device 30 can be designed to provide at least one, in particular at least two different, voltage levels.

The plug-in connection part 4 has a communication device 31, in particular a modulator/demodulator assembly and/or modem assembly, for exchanging energy and/or signals via the primary coil 23.

The plug-in connection part 4 can have a control device 32, in particular a digital assembly, in particular comprising an electronic processing unit. The control device 32 is designed to control the data transmission between the circuit connection 29 and the primary coil 23, in particular the communication device 31.

The plug-in connection part 4 has an amplifier device 33. The amplifier device 33 comprises an electrical resonant circuit 34. The resonant circuit 34 comprises the primary coil 23 and at least one capacitor 35.1, 35.2. The amplifier device 33 further comprises a switch 36, in particular an electronic switch, in particular a transistor.

A supply inductor 37 is connected upstream of the resonant circuit 34. The supply inductor 37 is arranged along the electrical line between the power conditioning device 30 and the resonant circuit 34, in particular the switch 36, in particular electrically contacted, in particular connected in series thereto. The supply inductor 37 is designed in such a way that the resonant circuit 34 is damped as little as possible by the supply inductor 37. For this purpose, the supply inductor 37 should be as high as possible.

However, in order to avoid efficiency losses as far as possible, the electrical resistance of the supply inductor 37 must also be reduced. As the available installation space is limited, there is a preferred range for the supply inductor 37 with regard to its electrical inductance, namely 0.01 mH to 1 H, in particular 0.1 mH to 100 mH, in particular 1 mH to 10 mH, in particular 3 mH to 7 mH. This applies in particular if a carrier signal frequency for switching the primary coil 23, which is in particular produced by means of the switch 36, is in a range of 10 kHz to 10 MHz, in particular 100 kHz to 1 MHz, in particular 150 kHz to 400 kHz.

The switch 36 is in signal connection with the control device 32. The communication device 31 is in signal connection with the primary coil 23.

A smoothing capacitor 38 can be connected to the circuit connection 29, in particular to the operating voltage contact 29.1 and/or to the supply inductor 37, in particular on the side of the circuit connection 29, for voltage smoothing.

According to an alternative embodiment, the capacitor 38 can represent the overall capacitance of the electrical circuit 28. According to this alternative, the capacitor 38 is not necessarily present in the form of a single component or at the indicated position within the circuit 28.

The plug-in connection part 4 has an ignition suppression means 39 in the circuit 28 for preventing ignition in the event of a fault by limiting the back action of the electrical energy to the circuit connection 29. The ignition suppression means 39 is in particular directly connected to the circuit connection 29, in particular electrically contacted between the circuit connection 29 and the power conditioning device 30.

The components of the circuit 28, in particular of the plug-in connection part 5, are preferably at least partially, in particular predominantly, in particular completely, arranged on at least one, in particular one single, primary circuit board 40. In particular, the ignition suppression means 39 and the amplifier device 33 are arranged on the primary circuit board 40.

The ignition suppression means 39 is preferably arranged between the operating voltage contact 29.1 and/or the reference potential contact 29.2, in particular parallel to the amplifier device 33 and/or the power conditioning device 30.

The ignition suppression means 39 has at least four, in particular at least five, diodes 41.1, 42.1, 43.1, 44.1, 45.1, in particular rectifier diodes, in particular Schottky diodes. The first diode 41.1 is arranged between the operating voltage contact 29.1 and the first signal line contact 29.3. The second diode 42.1 is arranged between the first signal line contact 29.3 and the reference potential contact 29.2. The third diode 43.1 is arranged between the operating voltage contact 29.1 and the second signal line contact 29.4. The fourth diode 44.1 is arranged between the second signal line contact 29.4 and the reference potential contact 29.2.

The ignition suppression means 39 preferably has a Zener diode 45.1, which is arranged between the operating voltage contact 29.1 and the reference potential contact 29.2.

Four other diodes 41.2, 42.2, 43.2, 44.2, in particular rectifier diodes, in particular Schottky diodes, are preferably provided, whose respective arrangement corresponds to the arrangement of the diodes 44.1, 42.1, 43.1, 44.1, wherein they supplement each other in pairs in a parallel connection. A second Zener diode 45.2 can be arranged in accordance with the first Zener diode 45.1 and supplement it in a pair in a parallel connection.

The embodiment of the ignition suppression means 39 described above with the paired arrangement of the diodes 41.1 to 45.1 and 41.2 to 45.2 or the Zener diodes 45.1, 45.2 results in double redundancy. This redundancy is not necessarily required. Multiple redundancy, in particular at least double redundancy, in particular at least triple redundancy, ensures that the ignition suppression means is particularly reliable.

The connection cable 24 can have a shield. The plug-in connection part 4 and/or the mating plug-in connection part 5, in particular the circuit 28 and/or the secondary circuit 9, can have potting. In particular, the respective circuit 9, 28 can be encapsulated in a fluid-tight, in particular gas-tight manner. The respective housing 6, 21 can be filled with a potting compound, in particular completely. This prevents ignition in the region of the plug-in connection part 4 and/or the mating plug-in connection part 5 particularly reliably.

The measuring system 1, connecting device 2, plug-in connection part 4 and ignition suppression means 39 operate as follows:

The plug-in connection part 4 is initially separated from the mating plug-in connection part. The thread 7 is screwed to the measuring chamber wall. The sensor is designed as a pH sensor and arranged in the measuring chamber, in particular at a measuring point. The mating plug-in connection part 5 is ready for reversible connection to the plug-in connection part 4.

In order to inductively transmit energy and/or signals between the plug-in connection part 4 and the mating plug-in connection part 5, these are plugged together. The primary coil 23, in particular the cylindrical protrusion 22 of the housing 21 of the plug-in connection part 4, is inserted into the secondary coil 11, in particular into the recess 13 of the housing 6 of the mating plug-in connection part 5. The plug-in connection is locked by means of the locking mechanism 5a. The plug-in connection forms a mechanical connection between the plug-in connection part 4 and the mating plug-in connection part 5. At the same time, a connection is established for inductively transmitting energy and/or signals, by the arrangement of the primary coil 23 in the secondary coil 11.

The connecting device 2, in particular the plug-in connection part 4, is supplied with electrical energy via the circuit connection 29, in particular via the operating voltage contact 29.1 and the reference potential contact 29.2. The electrical energy is preferably provided by the signal processing device 25 and conducted via the connection cable 24 to the circuit connection 29.

The signal processing device 25 is preferably designed to be intrinsically safe in terms of explosion protection, in particular electrical ignition protection.

The plug-in connection part 4 has components which store electrical energy. In particular the amplifier device 33, in particular the supply inductor 37 and the capacitors 35.1, 35.2, the primary coil 23 and the smoothing capacitor 38 act as storage devices for electrical energy. The stored energy can cause ignition in the event of a fault, which is in particular independent of the intrinsically safe design of the signal processing device 25. The potential ignition results in particular from the energy storage capacity of the amplifier device 33, in particular supply inductor 37, which has a comparatively high electrical inductance for energy-efficient signal transmission.

In order to reliably prevent ignition in the event of a fault, potential back action of the stored electrical energy to the circuit connection 29 is limited in its extent by means of the ignition suppression means 39. The ignition suppression means 39 in particular prevents ignition, in particular an ignition spark, in the event of the connection cable 24 breaking or the connection cable 24 being improperly disconnected from a connection point, for example to the signal processing device 25.

The ignition suppression means 39 ensures a voltage limit between two, preferably between all, of the contacts 29.1 to 29.4. This reliably prevents in particular an inductor, in particular the supply inductor 37, from generating a voltage at the circuit connection 29, in particular between two contacts 29.1 to 29.4, that is high enough to cause spark ignition.

The forward voltage range of the diodes 41.1 to 44.1, 41.2 to 44.2 can be in a range of 0 V to 10 V, in particular 0.1 V to 5 V, in particular 0.2 V to 2 V, in particular 0.5 V to 1 V. The same preferably applies to the at least one Zener diode 45.1, 45.2. The at least one Zener diode 45.1, 45.2 can have a breakdown voltage in a range of 0.1 V to 10 V, in particular 0.5 V to 8 V, in particular 1 V to 7 V, in particular 2 V to 6 V.

The plug-in connection part 4 formed with the ignition suppression means 39 ensures in particular that ignition is prevented in the region of the connection cable 24.

Ignition suppression is further enhanced by the fact that the connection cable 24 has an in particular electrical and/or magnetic shield and/or by the fact that the circuit 28 is enclosed with an encapsulation, in particular potting, in particular potting made of a non-electrically conductive material, in particular a plastic material.

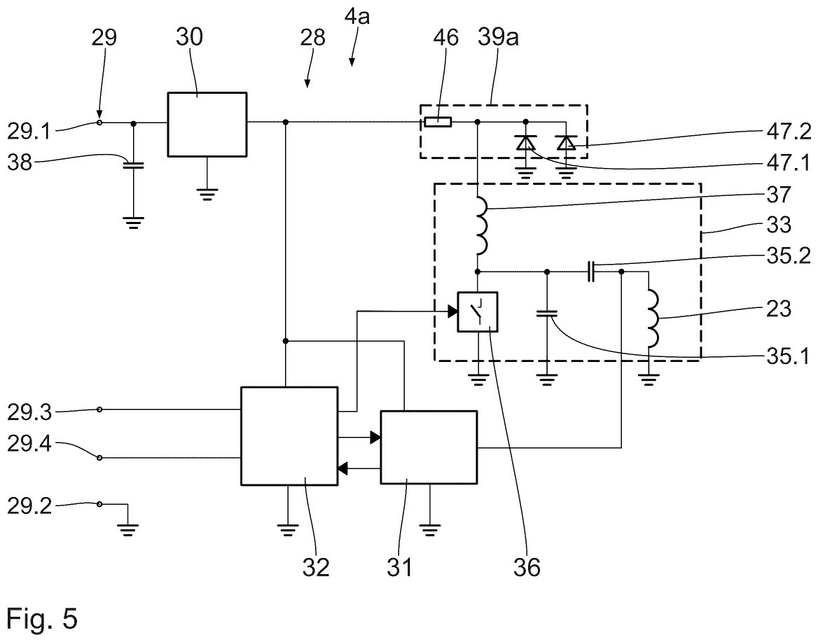

Another embodiment of a plug-in connection part 4a, in particular an ignition suppression means 39a, is described with reference to FIG. 5. The plug-in connection part 4a is different from the embodiment described above in the design of the ignition suppression means 39a. Otherwise, the design of the plug-in connection part 4a corresponds to that of the plug-in connection part 4a described above.

The ignition suppression means 39a is electrically contacted between the operating voltage contact 29.1, in particular the power conditioning device 30 and/or the smoothing capacitor 38, and the amplifier device 33, in particular the supply inductor 37.

The ignition suppression means 39a has an electrical resistor 46, which is arranged in particular in a series connection between the power conditioning device 30 and the amplifier device 33. The ignition suppression means 39a has two diodes 47.1, 47.2, in particular rectifier diodes, in particular Schottky diodes. As an alternative to the Schottky diodes, Zener diodes could be used. These are arranged between the power conditioning device 30 and the amplifier device 33 on the one hand and the reference potential contact 29.2 on the other, in particular parallel to the amplifier device 33, in particular to the energy supply connection of the amplifier device 33, and/or to the supply inductor 37 and/or to the primary coil 23.

The ignition suppression means 39a formed in this way prevents back action of the electrical energy stored in the amplifier device 33 to the circuit connection 29. In particular, the maximum voltage and/or energy that can be generated between the power supply contacts 29.1, 29.2, in particular by the amplifier device 33, is limited. This prevents the voltage and/or energy required to cause an ignition spark from being reached.

The embodiment of the ignition suppression means 39a with the resistor 46 limits the maximum electrical power that can be transmitted in particular by the amplifier device 33 to the circuit connection 29. The resistor 46 is optional.

The redundant design of the diodes 47.1, 47.2 is also optional. Multiple redundancy of the diodes 47.1, 47.2, in particular double redundancy, in particular triple redundancy, is advantageous.

The measuring system 1, in particular the connecting device 2, in particular the plug-in connection part 4a, advantageously ensure that ignition is reliably prevented in the event of a fault, in particular if the connection cable 24 breaks or in the event of improper use.

The amplifier device 33 ensures the signal transmission between the plug-in connection part 4a and the mating plug-in connection part 5 in a particularly reliable and robust manner. The resulting increase in electrical energy that can be stored by the plug-in connection part 4a is potentially sufficient to provide ignition, particularly in the connection cable 24. The ignition suppression means 39a advantageously ensures that back action of the electrical energy stored in the plug-in connection part 4a to the circuit connection 29 is reliably prevented. The ignition suppression means 39a reliably prevents an energy output required for a spark ignition and/or thermal ignition at the circuit connection 29, in particular at the connection cable 24, from being reached. The plug-in connection part 4a can be safely and reliably operated in a potentially explosive environment.

The signal processing device 25 is preferably also designed to be intrinsically safe in terms of explosion protection. Such a measuring system 1, in particular comprising the connecting device 2 described above and the signal processing device 25 designed to be intrinsically safe, is particularly robust in operation and can be safely operated in a potentially explosive environment.

1-18. (canceled)

19. A plug-in connection part (4, 4a) for inductively transmitting energy and/or signals in a potentially explosive environment, comprising:
an electrical circuit (28) with a circuit connection (29) for supplying the plug-in connection part (4) with electrical energy;
a primary coil (23) in the electrical circuit (28) for inductive coupling with a secondary coil (11); and
an ignition suppression means (39, 39a) in the electrical circuit (28) for preventing ignition in an event of a fault by limiting a back action of the electrical energy to the circuit connection (29),
wherein the ignition suppression means (39, 39a) has at least one diode (41.1 to 45.1, 41.2 to 45.2, 47.1, 47.2) for limiting a maximum connection voltage at the circuit connection (29), and
wherein the ignition suppression means (39, 39a) is directly connected to the circuit connection (29).

20. The plug-in connection part (4, 4a) according to claim 19,
wherein the electrical circuit (28) has an amplifier device (33) for amplifying the energy and/or signals which are supplied to the primary coil (23).

21. The plug-in connection part (4, 4a) according to claim 20,
wherein the amplifier device (33) has an overall electrical inductance of at least 0.1 mH.

22. The plug-in connection part (4, 4a) according to claim 20,
wherein the ignition suppression means (39, 39a) is contacted in the electrical circuit (28) between the amplifier device (33) and the circuit connection (29).

23. The plug-in connection part (4, 4a) according to claim 19, further comprising
a power conditioning device (30), the power conditioning device (30) being contacted in the electrical circuit (38) between the circuit connection (29) and the ignition suppression means (39, 39a).

24. The plug-in connection part (4, 4a) according to claim 19, further comprising
a connection cable (24) at the circuit connection (29),
wherein the ignition suppression means (39, 39a) is designed to prevent ignition in the connection cable (24).

25. The plug-in connection part (4, 4a) according to claim 19,
wherein the ignition suppression means (39, 39a) is designed to limit electrical energy and/or power potentially contributing to the ignition of a potentially explosive composition in the potentially explosive environment.

26. The plug-in connection part (4, 4a) according to claim 19,
wherein the ignition suppression means (39, 39a) is designed to dissipate electrical energy stored in the electrical circuit (28).

27. The plug-in connection part (4, 4a) according to claim 19,
wherein the ignition suppression means (39, 39a) has at least two of the diodes (41.1 to 45.1, 41.2 to 45.2) between two power supply contacts (29.1, 29.2) of the circuit connection (29).

28. The plug-in connection part (4) according to claim 19,
wherein the ignition suppression means (39) respectively has at least two rectifier diodes (41.1, 41.2) between an operating voltage contact (29.1) of the circuit connection (29) and a first signal line contact (29.3) of the circuit connection (29), between the first signal line contact (29.3) and a reference potential contact (29.2) of the circuit connection (29), between the operating voltage contact (29.1) and a second signal line contact (29.4) of the circuit connection (29), and between the second signal line contact (29.4) and the reference potential contact (29.2).

29. The plug-in connection part (4) according to claim 19,
wherein the ignition suppression means (39) has at least two Zener diodes (45.1, 45.2) between two power supply contacts (29.1, 29.2) of the circuit connection (29).

30. The plug-in connection part (4a) according to claim 23,
wherein the ignition suppression means (39a) has the at least one diode (41.1 to 45.1, 41.2 to 45.2, 47.1, 47.2) and at least one resistor (46),
wherein the power conditioning device (30) is contacted in the electrical circuit (28) between the ignition suppression means (39a) and an operating voltage contact (29.1) of the circuit connection (29).

31. The plug-in connection part (4, 4a) according to claim 19,
wherein an energy storage capacity of the plug-in connection part (4, 4a) exceeds an ignition limit when the plug-in connection part (4, 4a) is used as intended.

32. A connecting device (2), comprising:
the plug-in connection part (4, 4a) according to claim 19, and
a mating plug-in connection part (5) for reversibly releasable connection to the plug-in connection part (4, 4a).

33. A measuring system (1), comprising:
at least one sensor (3), and
the connecting device (2) according to claim 32.

34. The measuring system (1) according to claim 33, further comprising
a signal processing device (25) for processing signals transmitted via the connecting device (2).
